(19) United States
(12) Patent Application Publication
(10) Pub. No.: US 2013/0182023 A1
(43) Pub. Date: Jul. 18, 2013

(54) INK SUPPLY SYSTEM FOR PRINTER

(71) Applicant: PAMNRED CORP., TAIPEI CITY (TW)

(72) Inventor: PEI-CHUN HUNG, TAIPEI CITY (TW)

(73) Assignee: PAMNRED CORP., TAIPEI CITY (TW)

(21) Appl. No.: 13/741,506

(22) Filed: Jan. 15, 2013

(30) Foreign Application Priority Data
Jan. 16, 2012 (TW) 101101573

(51) Int. Cl. B41J 2/175

(52) U.S. Cl. CPC B41J 2/17596
USPC 347/6

(57) ABSTRACT

An ink supply system for printer to supply ink to a printer head includes an ink reservoir, a filter connected to an outlet end of the ink reservoir, a pump arranged at a front end of the filter, a pressure chamber connected to a front end of the pump, a valve arranged at a front end of the pressure chamber, a pressure sensor connected to the valve by a tube, and a controller for controlling the pump and the valve. The pressure sensor is arranged adjacent to the printer head to detect the ink pressure in the tube, and transmits a pressure signal to the controller. The pump can pump the ink forward to increase ink pressure or rearward to decrease ink pressure.

### BACKGROUND OF THE INVENTION

1. Field of the Invention

The present invention relates to an ink supply system for printer; in particular, to a system which supplies ink from an ink reservoir to a printer head, such as an ink supply system for printer for printing pictures or text on paper or surfaces of objects.

2. Description of Related Art

With the development of printing technologies, the size of printers is becoming smaller and smaller, and the quality of the same better and better. However most printers need to be fixed on desks during use, wherein the pressure difference between the printer head and the ink reservoir is constant.

If the ink supply system is to be applied on a portable printer, such as a printer which can directly print on products, the orientation of the hand held printer varies as it moves to print different sides of an object. Given this, not only is miniaturization a necessary consideration for the ink supply system, but also the method of overcoming varying pressure difference resulting from changes in orientation of the printer for preventing over or under supply of ink.

Additionally, consideration must be given to preventing air or contaminants from entering ink tubes in order to avoid inconsistent printing quality or contaminated ink, and even to methods of cleaning printer heads. Therefore making a small size printer accomplish the above functions is a significant task in the current industry.

Hence, the present inventor believes the above mentioned disadvantages can be overcome, and through devoted research combined with application of theory, finally proposes the present disclosure which has a reasonable design and effectively improves upon the above mentioned disadvantages.

### SUMMARY OF THE INVENTION

The object of the present disclosure is to provide a printer ink supply system which automatically adjusts its ink supplying pressure to match its orientation.

Additionally, another object of the present disclosure is to provide a printer ink supply system, which not only maintains a good quality of printing with a consistent supply of ink, but also prevents air or contaminants from entering ink tubes.

In order to achieve the aforementioned objects, the present disclosure provides a printer ink supply system for supplying ink to a printer head. The ink supply system includes:

an ink reservoir, having an outlet end;

a filter, connected to the outlet end of the ink reservoir;

a pump disposed at a frond end of the filter;

a controller for controlling the pump to increase or decrease the ink supply pressure by respectively pushing the ink forward or rearward;

a pressure chamber, connected to a front end of the pump;

a valve disposed at a front end of the pressure chamber, wherein the controller controls the opening and closing of the valve; and

a pressure sensor, wherein the pressure sensor and the valve are disposed between the pressure chamber and the printer head and proximally to the printer head for sensing the ink pressure within the tube, and the pressure sensor transmits the detected pressure to the controller.

The present disclosure has at least the following advantages: by an automatic pressure compensation of the ink supply system, the ink supply can be consistent regardless of the orientation of the printer in order to maintain a good printing quality. Additionally the present disclosure also supports subsequent maintenance procedures, such that the printer can be well maintained and operated.

In order to further the understanding regarding the present disclosure, the following embodiments are provided along with illustrations to facilitate the disclosure of the present invention but are not intended to limit the same.

### BRIEF DESCRIPTION OF THE DRAWINGS

FIG. 1 shows a perspective diagram of an ink supply system for printers of the present disclosure;

FIG. 2 shows a perspective diagram of an ink supply system for printers of another embodiment of the present disclosure;

FIG. 3 shows a structure chart of an ink supply system for printers of the present disclosure; and

FIG. 4 shows a flow chart of a normal ink supply procedure of an ink supply system of the present disclosure.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

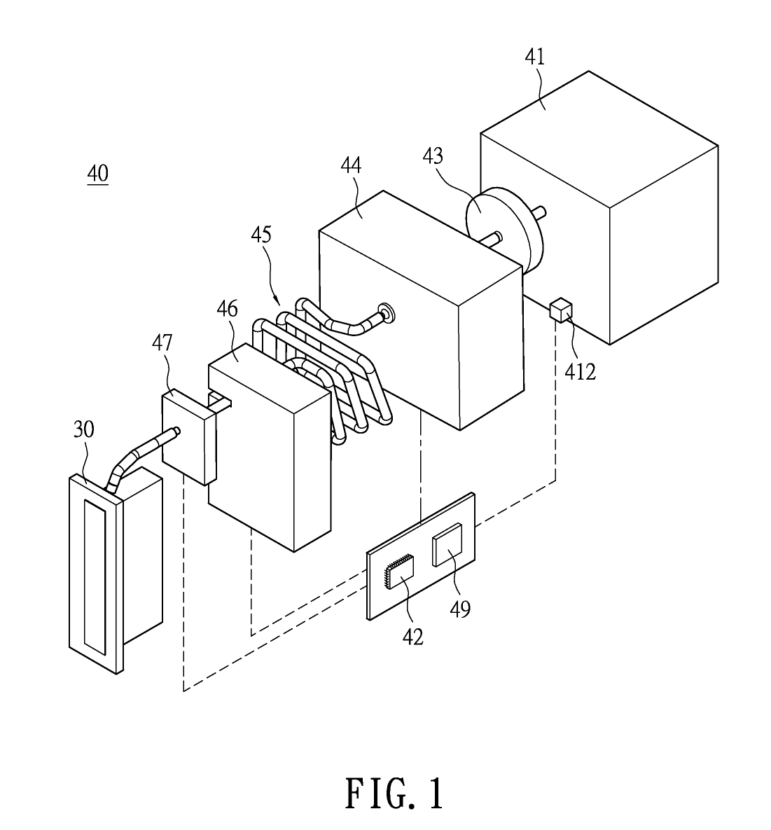

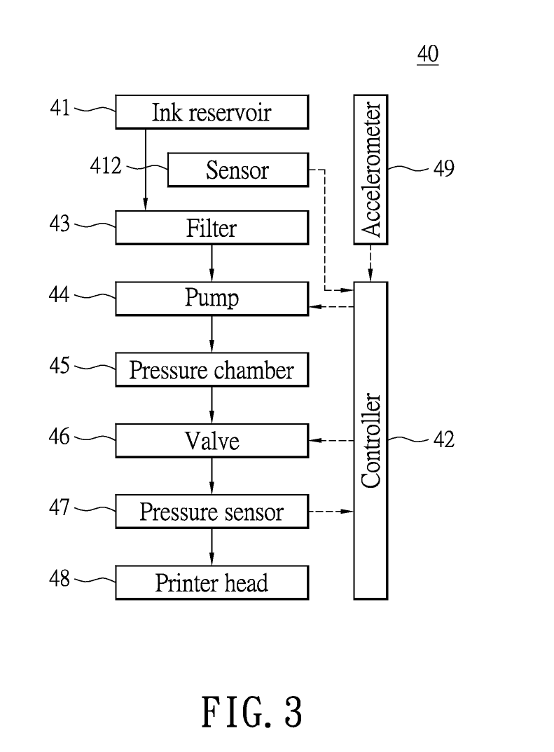

Referring to FIG. 1 and FIG. 3, FIG. 1 shows a perspective diagram of an ink supply system for printers of the present disclosure, and FIG. 3 shows a structure chart of the same. The ink supply system 40 of the present disclosure can be disposed on portable printers, desktop printers, etc, for supplying ink to printer heads 30. The ink supply system includes an ink reservoir 41, a controller 42, a filter 43, a pump 44, a pressure chamber 45, a valve 46, a pressure sensor 47, and an accelerometer 49. The pressure sensor 47 is proximal to the printer head 30. The accelerometer is proximal to the printer head 30, or positioned anywhere within the ink supply system 40. The front is defined as being closer to the printer head 30, and the rear as being closer to the ink reservoir 41. In practice, the ink supply system of the present disclosure can coordinate with the printer and supply ink in any orientation, such as horizontal, vertical, or slanted; therefore the front and rear end are relative directions and not intended to limit the present disclosure. It must be mentioned that the ink supply system 40 of the present disclosure can include or not include a printer head 30.

An outlet end is formed on the ink reservoir 41. A sensor 412 is disposed proximally to the ink reservoir 41 for detecting the assembly state of the ink reservoir 41, namely to detect whether the ink reservoir 41 is detached or installed. The sensor 412 is electrically connected to the controller 42 and transmits the detected state to the controller 42 for appropriate processing. The sensor 412 can be a micro switch connected by touch, but is not limited herein.

The filter 43 is connected to the outlet end of the ink reservoir 41, for filtering potential impurities in the ink. The pump 44 is disposed on the front end of the filter 43. The pump 44 is electrically connected to the controller 42 from which it receives signals to push the ink forward (toward the printer head 30) or rearward (further away from the printer head 30) to respectively increase or decrease the ink supply pressure. The pump 44 of the present disclosure is ideally a two-way pump able to push the ink forward and rearward.

The pump 44 of the present disclosure is ideally a peristaltic pump, but is not limited herein. Other micropumps for pushing inks can also be used, such as piezo-electric micropump, etc. The operating principle of a peristaltic pump involves using multiple rollers rotating forward or rearward on a rotor to compress a flexible tube, thereby moving the fluid within the tube forward or rearward.

In an embodiment using the peristaltic pump, the tube connects the filter 43 and the pressure chamber 45, and passes through the rollers on the rotor of the peristaltic pump 44. The fluid moves only within the tube, and not over parts of the pump 44 or other elements. Neither the pump 44 nor the fluid is contaminated, keeping the volume of fluid pumped accurate. Additionally, rollers on rotors of the peristaltic pump roll and press the tube, forming a cutting point. When the rollers on the rotor roll, not only can they push the ink forward, but can also push the ink rearward to change the pressure within the tube at two ends.

The pressure chamber 45 is positioned at the front end of the pump 44. The valve 46 in turn is positioned at the front end of the pressure chamber 45. In other words, the pressure chamber 45 is disposed between the pump 44 and the valve 46. The pressure chamber 45 of the present embodiment can be formed by a tube wound into a coil with multiple loops as shown in FIG. 1. Due to the reserved length of the tube and the properties of the tube itself, pressure can be increased or decreased within the wound tube . The pressure sensor 47 of the present embodiment is disposed between the printer head 30 and the valve 46. Of particular note, the linear arrangement in the figure is only schematic. In practice, the pressure sensor 47 only needs to be proximal to the printer head 30, such as above, below, left or right of the printer head 30.

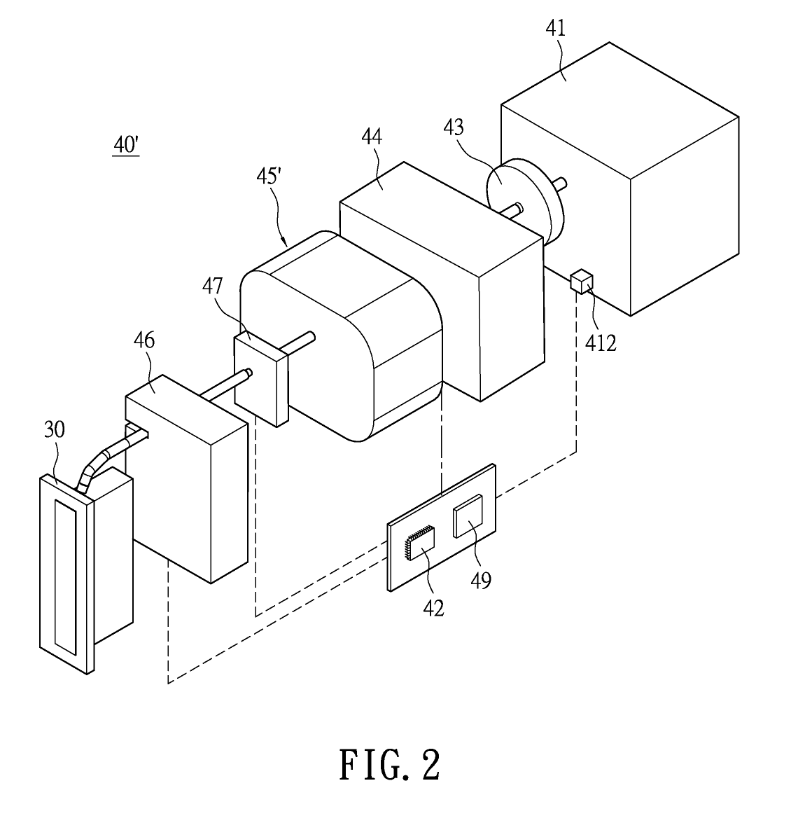

The present disclosure is not limited to the above method. As shown in FIG. 2 in another embodiment, the pressure chamber can be replaced by an enclosed container labeled as element 45′ in FIG. 2. The wound tube serving as a pressure chamber of the previous embodiment has the advantage of saving space and cost, and is easier to install. Additionally, ink does not have to flow through a container. Moreover, the pressure sensor 47 of the present disclosure can likewise be disposed between the pressure chamber 45′ and the valve 46. Namely, the valve 46 and the pressure sensor 47 can switch positions, achieving effects similar to that of the previous embodiment.

Referring again to FIG. 1, the valve 46 is electrically connected to the controller 42, and is opened or closed by the controller 42. The valve 46 of the present embodiment is ideally a pinch valve. The tube is opened and closed by the movement of the pinch head of the pinch valve. When the pinch head pinches the tube, another cutting point is formed. The pinch head is moved by electrically powered mechanisms, pneumatic methods, etc. The fluid flows only within the tube, and not over the valve. Neither the valve nor the fluid is contaminated. However, the present disclosure can also use other types of valves.

The tube passing through the valve 46 passes by the pressure sensor 47. The pressure sensor 47 is disposed proximally to the printer head 30, for measuring the pressure of the ink within the tube transferred to the printer head 30. Due to its proximity to the printer head 30, the pressure detected by the pressure sensor 47 is nearly identical to the ink pressure at the printer head 30. The pressure sensor 47 transmits the detected pressure to the controller 42, which accordingly controls the pump 44 to adjust the ink pressure of the ink supplied to the printer head 30.

An accelerometer 49, for example a G-sensor, is optionally disposed on the present disclosure, for detecting the orientation of the ink supply system 40, mainly for identifying the relative position of the printer head 30 to the pump 44 (for example, the printer head 30 is higher than the pump 44, lower than the pump 44, or the two are level) in order to provide supplemental calculations, thereby timely compensating the pressure difference caused by the relative positions of the printer head 30 to the pump 44.

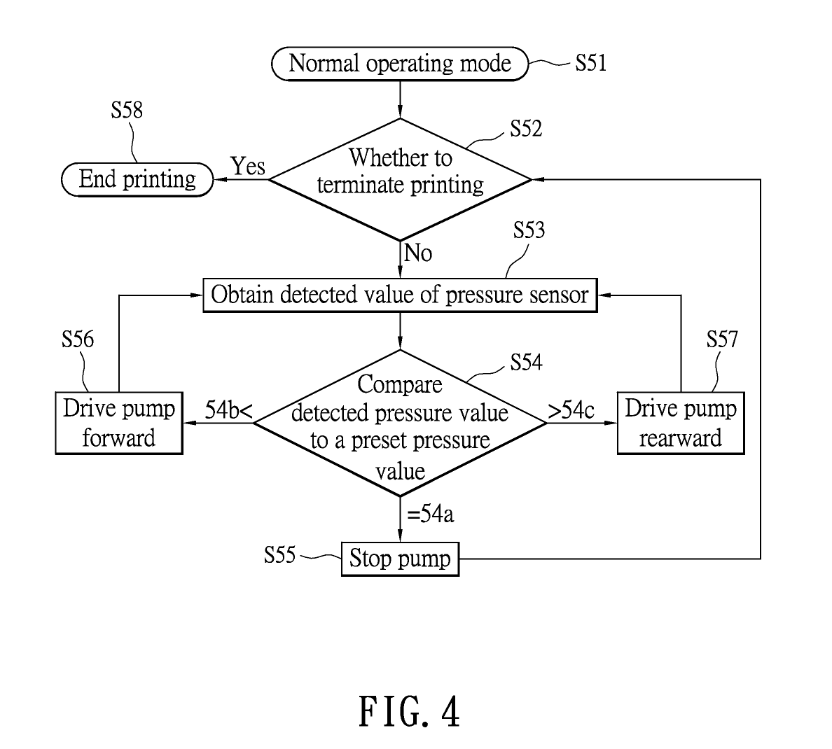

FIG. 4 shows a flow chart of a normal ink supply procedure of the ink supply system of the present disclosure. When the ink supply system of the present system is set at normal operating mode S51, the controller 42 carries out step S52 to detect whether to terminate printing. Termination of printing at this point can be because the ink supply system 40 has completed the printing job designated by the user, or because the user has interrupted the printing job. If printing is terminated, then step S58 is carried out to end the printing; if not, then step S53 is carried out wherein a pressure value detected by the pressure sensor 47, namely the ink pressure proximal to the printer head 30, is obtained. Then step S54 is carried out, wherein the detected pressure value is compared to a preset pressure value. The preset pressure value is the ideal ink pressure value needed within the tube for optimal printing performance by the printer head 30. Generally, the ideal ink pressure at the printer head 30 is a slight negative pressure, namely a pressure slightly lower than atmospheric pressure. The jetting procedure of ink is controlled by an internal control mechanism of the printer head 30, such as a piezoelectric printing head controller.

The above pressure comparison can be divided into three conditions:

First, in an equal-to condition 54a, step S55 is carried out, in which the pump is stopped without adjusting the pressure of the ink. Namely, the ink pressure of the ink transferred to the printer head 30 is neither increased nor decreased, and the procedure is returned to the aforementioned step of detecting whether to terminate printing.

In a less-than condition 54b, namely when the detected pressure value is less than the preset pressure value, step S56 is carried out, in which the pump 44 is driven forward to increase the pressure of ink supplied to the printer head 30 thereby avoiding an under-supply of ink, and the procedure is returned to the step where the pressure sensor detects the ink pressure.

In a more-than condition 54c, namely when the detected pressure value is greater than the preset pressure value, step S57 is carried out, in which the pump 44 is driven rearwards to decrease the pressure of ink supplied to the printer head 30 thereby avoiding an over-supply of ink, and the procedure is returned to the step where the pressure sensor detects the ink pressure.

With the ink supply system 40 of the present disclosure, the printer head 30 can supply ink in adequate amounts regardless of its orientation or printing speed, maintaining a good printing quality without experiencing an over or under supply of ink.

When a user wants to change the ink reservoir of the present disclosure, the sensor 412 of the present disclosure can detect whether the ink reservoir 41 is detached or installed. The ink supply system stops all operations, in order to prevent air or contaminants from entering the ink tube, and resumes operation only when installation of the ink reservoir is complete.

When the present disclosure is to be installed for the first time or to be emptied and cleaned, due to the length of the tube the user may trigger the priming mode, so as to force the ink within the tube toward the front end by the forward movement of the pump.

When the printer head 30 is clogged, the present disclosure can clean the printer head 30. The controller 42 closes the valve 46 and drives the pump 44 forward to increase the pressure within the pressure chamber 45. When the pressure chamber 45 reaches a preset pressure, the valve 46 is released and the pressurized ink is ejected from the printer head 30. The pressurized ink washes away clogs. The user can inspect whether the printer head 30 is clean enough for printing and decide whether to repeat the cleaning process or not.

In summary, the ink supply system for printers of the present disclosure has at least the following advantages:

Through an automatic compensation of pressure by the ink supply system, the printer can consistently supply ink for maintaining a good printing quality regardless of the orientation of the printer head. The ink supply system selectively uses all types of components suitable for installation in a small sized printer.

The ink supply system of the present disclosure can accurately supply ink to the printer head according to the orientation of the ink supply system. The ink supply system of the present disclosure can also execute a priming mode, for example during first-time installation or during emptying and cleaning. The ink supply system can also clean the printer head. The present disclosure not only provides high quality printing, but also supports subsequent maintenance procedures, such that the printer can be well maintained and operated.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. An ink supply system for printer, for supplying ink to a printer head, wherein the ink supply system comprises:
an ink reservoir, having an outlet end;
a filter, connected to the outlet end of the ink reservoir;
a pump, disposed at a front end of the filter;
a controller, for controlling the pump to push the ink forward and increase pressure of the supplied ink or to push the ink rearward and decrease pressure of the supplied ink;
a pressure chamber, connected to a front end of the pump;
a valve, disposed at a front end of the pressure chamber, wherein the controller controls the opening and closing of the valve; and
a pressure sensor, wherein the pressure sensor and the valve are disposed between the pressure chamber and the printer head, the pressure sensor is proximal to the printer head in order to detect the ink pressure within the tube, and the pressure sensor transmits the detected pressure value to the controller.

2. The ink supply system for printer according to claim 1, further comprising a sensor proximal to the ink reservoir for detecting the assembly status of the ink reservoir.

3. The ink supply system for printer according to claim 1, wherein the pump is a two-way pump.

4. The ink supply system for printer according to claim 3, wherein the pump is a peristaltic pump having multiple rollers on a rotor for compressing a tube in a forward or rearward direction.

5. The ink supply system for printer according to claim 4, wherein the pump presses the tube to form a cutting point, the valve pinches the tube to form another cutting point, the controller controls the pump to move forward or rearward for adjusting the ink pressure within the pressure chamber.

6. The ink supply system for printer according to claim 1, wherein the pressure chamber is formed by the tube wound into a coil with multiple loops.

7. The ink supply system for printer according to claim 1, wherein the valve is a pinch valve, having a pinch head for opening and closing the tube.

8. The ink supply system for printer according to claim 1, further comprising an accelerometer for detecting the orientation of the ink supply system and transmitting the detected signal to the controller.

9. The ink supply system for printer according to claim 1, wherein the pressure sensor is disposed between the printer head and the valve.

10. The ink supply system for printer according to claim 1, wherein the pressure sensor is disposed between the pressure chamber and the valve.
